(19) United States
(12) Patent Application Publication
(10) Pub. No.: US 2010/0289738 A1
(43) Pub. Date: Nov. 18, 2010

(54) Stone, Portable Hand Held Device for Inputting Characters Into a Computer, Cell Phone, or any Programmable Device

(75) Inventor: Craig Eugene Schoonover, Sunnyvale, CA (US)

Correspondence Address: Craig E. Schoonover, 580 Ahwanee Avenue #25, Sunnyvale, CA, 94085, US

(73) Assignee: Craig Eugene Schoonover, Sunnyvale, CA (US)

(21) Appl. No.: 12/478,635

(22) Filed: Jun. 4, 2009

Related U.S. Application Data
(60) Provisional application No. 61/178,003, filed on May 13, 2009.

(51) Int. Cl. G09G 5/00

(52) U.S. Cl. 345/156

(57) ABSTRACT

This is an input devices that allows any type of character to be quickly and easily entered into any computing device with one hand, while being held by the same hand. The characters are arranged in arrays that can be displayed in a format of rows and columns. The user maneuvers the cursor through the tables using wheel type directional switches that can index continuously if desired. Normally, the thumb moves one wheel, or a ball, which can move the cursor over both rows and columns, and the index finger moves the other wheel or ball which changes the characters in the rows or columns allowing access to an unlimited number of characters. When the user arrives at the desired character, a switch controlled by one of the other fingers on the same hand then enters that character into the device. Double clicking, or pressing the switch quickly twice can make necessary adjustments to the character as desired, such as capitalizing a letter, or adding an umlaut. This device can also be used for accessing window style icons allowing the user to navigate through the operating system.

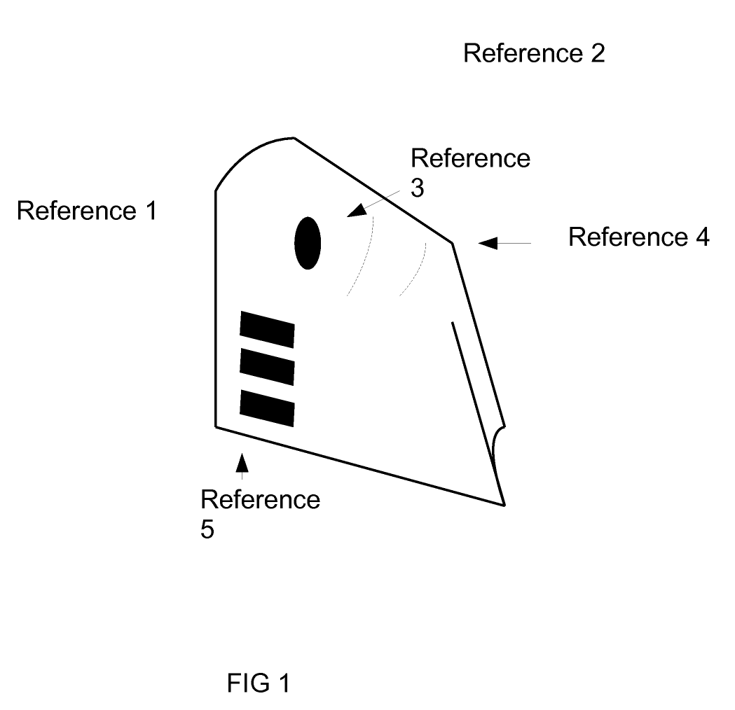

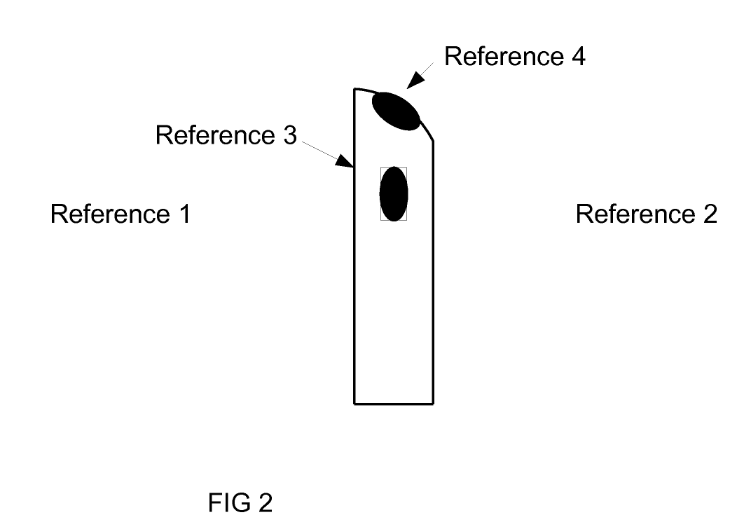

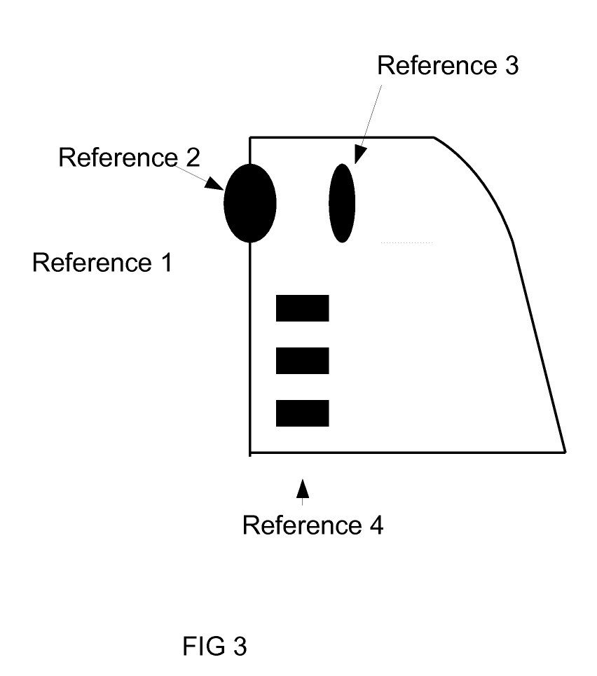

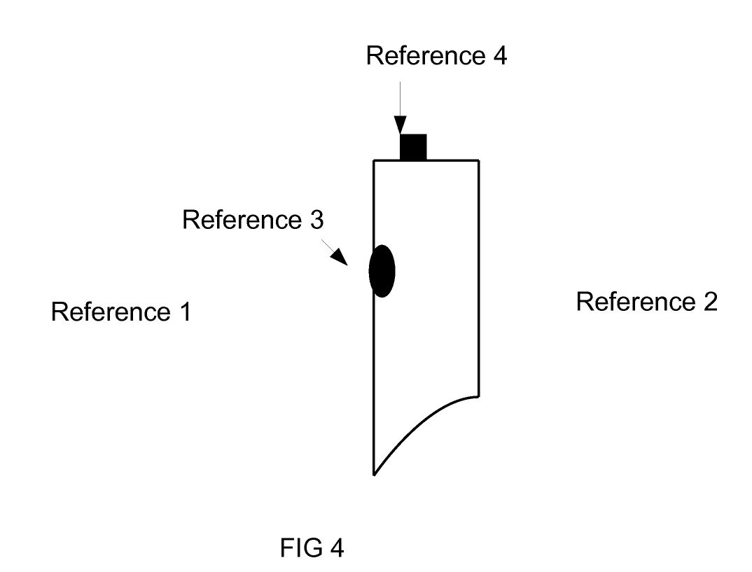

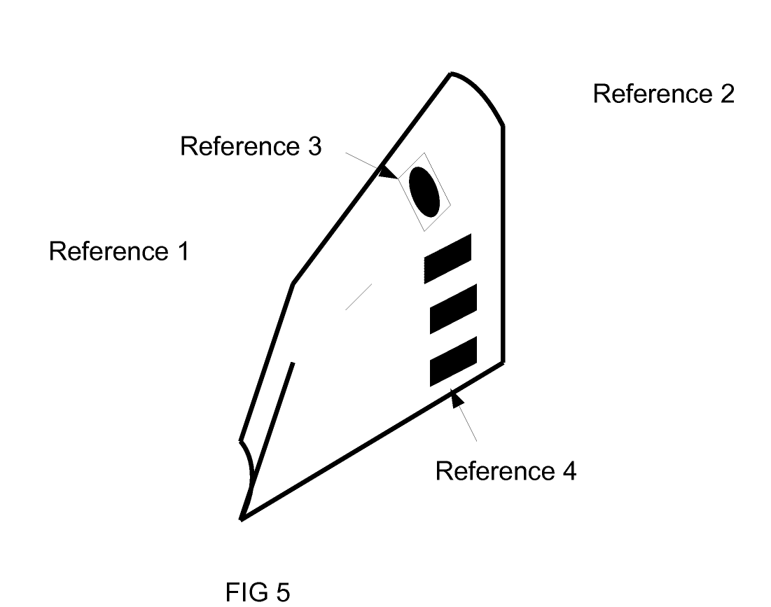

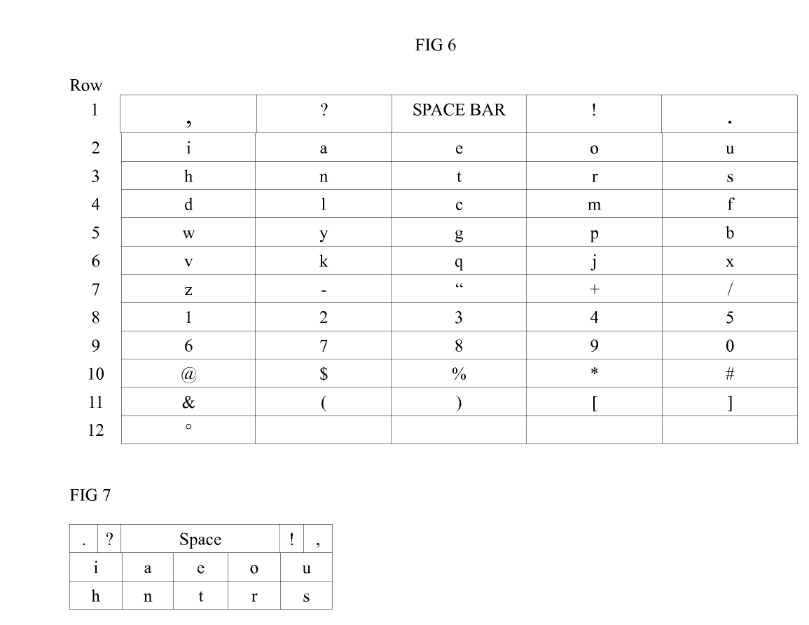

This is a non-provisional of Application No. 61/178,003 dated May 13, 2009

### FIELD OF INVENTION

This is an input device for a computer or computing device.

### BACKGROUND

In order to utilize digital computing devices of any type, there must be a way for the user to interface with the device. There are many devices for communicating with the computer that take many forms. This would be a new type of device for inputing characters into any type of computer or digital device that processes data, including cellphones, and other communication devices, which allows for greater mobility. As the capabilities of computers have increased, while at the same time the size of computers has been reduced, computers are being used in wider environments which increases the need for computers to be more portable, and accessible in these new arenas of life where they are being used. This device increases the portability and versatility for interfacing with computers by allowing people to enter data into a computer with a single hand easily and quickly, while performing other activities in virtually any type of environment. In addition, this device would be even more advantageous when working with different alphabets, all would be required is to offer the option in the software package.

### ATTACHED DRAWINGS

| FIG. | description |
|---|---|
| 1 | Stone - 3D - Right Hand Configuration |
| | Reference 1 - Front Side of Device |
| | Reference 2 - Palm Side of Device |
| | Reference 3 - Thumb ball or wheel |
| | Reference 4 - Trough for Thumb |
| | Reference 5 - Switches |
| 2 | Stone - Right hand configuration - Front side view |
| | Reference 1 - Palm Side of Device |
| | Reference 2 - Outside, Away from Hand Side, of Device |
| | Reference 3 - Index Finger Ball or Wheel |
| | Reference 4 - Thumb Ball or Wheel |
| 3 | Stone - Right Hand Configuration - Outside view away |
| | from palm |
| | Reference 1 - Front of Device |
| | Reference 2 - Index Finger Ball or Wheel |
| | Reference 3 - Thumb Ball or Wheel |
| | Reference 4 - Switches |
| 4 | Stone - Right Hand Configuration - Top View |
| | Reference 1 - Outside, Away from Hand, Side of Device |
| | Reference 2 - Palm Side of Device |
| | Reference 3 - Thumb Ball or Wheel |
| | Reference 4 - Index Finger Ball or Wheel |
| 5 | Stone - 3d - Left Hand Configuration |
| | Reference 1 - Palm Side of Device |
| | Reference 2 - Front Side of Device |
| | Reference 3 - Thumb ball or wheel |
| | Reference 4 - Switches |
| 6 | Table - Character Order for Stone |
| 7 | Table - Stone Display Interface |

Notes—The design is curved on the top from the palm side down towards the outside, and at the back from the outside in towards the palm side. The Curve at the back is to fit the ball of the thumb, and there is a trough at the top to fit the thumb, making the device ergonomic and easy to grip. Cell borders do not need to be displayed. Size of displayed table can be changed to fit the environment.

### SUMMARY OF THE DEVICE

This input devices allows one hand to input any type of character quickly and easily into any computing device, telephone or communication device, and any type of electronic equipment where the user needs to communicate with the device using characters of any sort. There is no need for a surface to place the device for usage, or to hold the device with the other hand, or have the device held in any manner, other than that hand that is inputing the data. Characters are input using a combination of switches in combination with a program that allows the user to scroll through and select the desired characters.

The characters are arranged in arrays which any user can alter to improve their application of this device, that can be displayed in a table format or spreadsheet format, or any type of format where the characters are arranged in rows and columns addressable by co-ordinates often referred to as X and Y co-ordinates. The character entry could also be used with an audio device that auditorily tells the user what row and column, and what character they are pointing at with the control wheels.

The user maneuvers the cursor through the tables using wheel type directional switches that can index continuously if desired. Typically, the thumb moves one wheel, or a ball, which moves the cursor over rows and columns, and the index finger moves the other wheel or ball which scrolls the rows or columns of characters, allowing access to an unlimited number of characters. One wheel controls movement of the cursor. The second wheel scrolls through the characters available on the visual or auditorial table at one time. When the user arrives at the desired character, a switch controlled by another finger on the same hand then enters that character into the computer. Double clicking, or pressing the switch quickly twice can make necessary adjustments to the character as desired, such as capitalizing a letter, or adding an umlaut. Two other switches are also provided for the other fingers which allow the user to use the device as a mouse, or any other practical application.

This device can be manufactured in any number of ways using a wide variety of materials. The unique properties are the application and positioning of the switches, the general shape of the device, combined with the accompanying program which allows access to characters having a symbolic meaning. The accompanying program can be developed in a number of ways, typically in arrays, where the characters are arranged in an organized manner of rows and columns for visual display, or auditory access that allows a cursor to interact with the characters and the field of characters to be changeable in an organized manner. Allowing the specifics of the hardware and the software to be composed according to need greatly increases the ability to make this device for any type of environment or system.

What is claimed is a portable device for inputing characters into a computing device that is held in one hand and operated independently with that same hand.

1. Method of inputing characters having a symbolic meaning into a computer, communication device, or control system with a hand held device that can be held in one hand and operated independently with that same hand, working with a program that arranges the characters into a form of columns and rows that allows selection of a set of character limited only by the memory of the device:
wherein the shape of the device and the arrangement of the buttons, wheel, or ball allow all five digits (fingers or thumb) independent, ergonomic control of a button, wheel, or ball which controls a single switch or multiple switches which are used in combination with each other,
wherein a wheel or ball controlled by one finger or the thumb scrolls up or down the rows or columns changing the characters available on the screen for selection,
wherein a wheel or ball controlled by one finger or the thumb controls the cursor allowing any character displayed on the screen to be selected,
wherein one of the other three fingers enters the chosen character into the text area, and the other two fingers are able to enter an edit mode, and chording of these three keys allows using this device to enter into a mouse mode for accessing windows style operating system,
wherein double clicking the entry switch allows capitalization of letters or addition of special characters such as umlauts.

2. The method of claim 1 further comprising of any combination of switch types, variable resistive devices, or both, allowing single or multiple switch positions, continuous bi-directional input of on and off, high and low, or analog values or any combination of these types of inputs to allow input into the computer or control system that allows access to data.

3. The method of claim 1 further comprising of a switch or switches or variable resistive devices, operated by one digit, which uses a ball to control the cursor or pointer for selection of specific characters and also scrolls through the data, allowing different sets of characters to be made available through the output device so that an expandable set of desired characters can be accessed.

4. The method of claim 1 further comprising of using the other switches operated by the other fingers, working best using the pinky finger to select the character the cursor points to for entry into the text field, using the middle finger to backspace causing entry into an edit mode, and the ring finger to delete characters, with the pinky finger moving the cursor forward in the text field and double clicking to insert text in the middle of text while in the edit mode, and moving forward to the end of the current composition to enter normal entry mode.

5. The method of claim 1 further comprising of usage of an auditory device that verbally gives the row, and the letter in the column when scrolling through the tables for entry, so that this device can be used without the visual output device.

6. The method of claim 1 further comprising of the switches being used in conjunction with a software program or digital device that allows one to choose what desired characters they want to be entered and arranged on the computer output display device so that the hand held device for inputing characters can scroll through the chosen desired character set in order to highlight the desired character for input, which allows the characters displayed to be customized to the users discretion.

7. The method of claim 1 further comprising of the ability to use two of these devices at the same time, one in each hand, in order to more quickly enter characters.
Independent claim

8. The configuration of the positions of the switches and the shape as displayed in the attached drawings for the best configuration of the device.

9. The method of claim 8 further comprising of the ability to configure and shape the device and switches for left hand or right hand use, and for varying hand sizes and shapes.

10. The method of claim 8 further comprising of the ability to configure the scrolling wheel or balls to different resolutions so that speed of movement of the cursor and character display can be adjusted to suit the needs of the user.
Independent claim

11. Software arranging the characters in columns and rows, or similar method, which can be used on a screen and allows the user of the hand held device to scroll through a possible infinite set of symbols arranged in an organized manner for ease and quickness of access.

12. The method of claim 11 further comprising of the arrangement of characters in attached table titled “Stone Alphabet and numerals organization chart” for best accessibility of characters.

13. The method of claim 11 further comprising of the display configuration in the attached table titled “Stone Character Display” for best number of rows and columns.
